(19) United States
(12) Patent Application Publication
(10) Pub. No.: US 2022/0375008 A1
(43) Pub. Date: Nov. 24, 2022

(54) Impact Calculation Apparatus and Impact Calculation Method

(71) Applicant: Nippon Telegraph and Telephone Corporation, Tokyo (JP)

(72) Inventors: Masahiro Sotoma, Musashino-shi, Tokyo (JP); Masayuki Tsuda, Musashino-shi, Tokyo (JP)

(21) Appl. No.: 17/772,822

(22) PCT Filed: Nov. 5, 2019
(86) PCT No.: PCT/JP2019/043258

§ 371 Date: Apr. 28, 2022

(51) Int. Cl. G06Q 50/06; G06Q 50/30

(52) U.S. Cl. CPC G06Q 50/06; G06Q 50/30

(57) ABSTRACT

An impact level calculation device includes a primary impact direction setting unit, which sets a primary impact direction based on the direction in which a branch line of a utility pole with a branch line is strung, an impact range setting unit, which sets, based on the primary impact direction, an impact range representing the range of the damage caused when the utility pole tilts or collapses, and an impact level calculation unit, which extracts targets that fall within the impact range and calculates and sums the impact levels on each of the targets, and the impact level calculation device calculates an impact level representing the level of damage caused to surroundings of the utility pole with a branch line when the utility pole tilts or collapses.

### TECHNICAL FIELD

The present invention relates to an impact level calculation device and an impact level calculation method.

### BACKGROUND ART

Utility poles (including telegraph poles, power poles, and other poles) installed across the country are responsible for holding communication cables and power cables. Earthquakes, typhoons, or sudden accidents can cause the utility poles to tilt significantly, or in the worst case, collapse. In preparation for such a case, it is beneficial for risk management to calculate the magnitude of damage caused to the surroundings of a utility pole when the utility pole tilts or collapses.

In many cases, a single utility pole may have a plurality of strung cables extending in different directions, and heavy objects, such as a transformer, may also be attached to the utility pole. It is assumed that the cables described above include not only what are called power lines and communication lines but any force transmitting object, such as suspension lines. How external forces act on the utility pole is therefore complex. A utility pole from its edge at the ground to its top is typically maintained roughly perpendicular to the ground but tilts in some cases depending on how external forces act on the utility pole. An external force that causes the utility pole to tilt with respect to the ground by an angle greater than or equal to a specified normal value is hereinafter referred to as an unbalanced load. The unbalanced load used herein means an external force in the normal environment and does not mean an external force caused, for example, by typhoons or earthquakes.

To correct the tilt of a utility pole due to the unbalanced load, a branch line is used in many cases. The branch line pulls the utility pole in the direction opposite to the direction of the unbalanced load to keep the forces acting on the utility pole balanced.

### CITATION LIST

### Non-Patent Literature

Non-Patent Literature 1: Shinsuke Sakai, “Rationalization of Maintenance Planning through Risk-Based Maintenance,” Operations research as a management science, The Operations Research Society of Japan, Sep. 1, 2012, Vol. 57, No. 9, pp. 493-499

### SUMMARY OF THE INVENTION

### Technical Problem

When a branch line loses its function for one reason or another, a risk of tilt or collapse of the utility pole increases depending on the situation in which the utility pole is present. Since the branch line is basically attached to resist the unbalanced load, it can be said that a utility pole with a branch line has a high risk of causing damage to the surroundings or deterioration of the communication environment due to tilt or collapse of the utility pole as compared with a utility pole with no branch line. It is beneficial for risk management to calculate the impact level of tilt or collapse of utility poles in general. In particular, it is more beneficial for risk management to understand the impact level of a utility pole with a branch line.

Some existing technical literatures refer to the impact level as a facility risk assessment (Non-Patent Literature 1, for example), but there is no technical literature that describes how to calculate the impact level in consideration of the characteristics specific to a utility pole with a branch line.

The present invention has been made in view of the circumstances described above, and an objective of the present invention is to evaluate the magnitude of damage caused to the surroundings of a utility pole with a branch line when the utility pole tilts or collapses.

### Means for Solving the Problem

An impact level calculation device according to an aspect of the present invention is an impact level calculation device for calculating an impact level representing a level of damage caused to surroundings of a utility pole with a branch line when the utility pole tilts or collapses, the device including a primary impact direction setting unit that sets a primary impact direction based on a direction in which the branch line of the utility pole is strung, an impact range setting unit that sets, based on the primary impact direction, an impact range representing a range of the damage caused when the utility pole tilts or collapses, and an impact level calculation unit that extracts targets that fall within the impact range and calculates and sums the impact levels on each of the targets.

### Effects of the Invention

The present invention allows evaluation of the magnitude of damage caused to surroundings of a utility pole with a branch line when the utility pole tilts or collapses.

### BRIEF DESCRIPTION OF DRAWINGS

FIG. 1 shows an example of a branch line attached to a utility pole.

FIG. 2 is a functional block diagram showing an example of the configuration of an impact level calculation device according to a first embodiment.

FIG. 3 shows the relationship between a branch line strung direction and a primary impact direction around a utility pole with a branch line.

FIG. 4 shows an example of an impact range.

FIG. 5 describes an example of calculation of an impact level.

FIG. 6 shows an example of facility information stored in a facility database.

FIG. 7 shows an example of environmental information stored in a facility environment database.

FIG. 8 is a flowchart showing the procedure of processes of calculating the impact level.

FIG. 9 is a functional block diagram showing an example of the configuration of the impact level calculation device according to a second embodiment.

FIG. 10 describes an example of calculation of a chain reaction impact level.

FIG. 11 is a flowchart showing the procedure of processes of calculating a chain reaction impact level.

FIG. 12 shows an example of the hardware configuration of the impact level calculation device.

### DESCRIPTION OF EMBODIMENTS

### First Embodiment

An impact level calculation device according to a first embodiment will be described below with reference to the drawings.

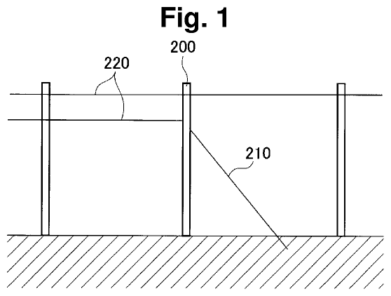

One or more cables 220 are installed at a utility pole 200, as shown in FIG. 1. A branch line 210 is attached so as to keep external forces acting on the utility pole 200 balanced. The branch line 210 has one end buried in the ground and has the function of pulling the utility pole 200 in the direction opposite to the direction of an unbalanced load. When the branch line 210 loses its function for one reason or another, the utility pole 200 is expected to tilt significantly or collapse in the direction in which the unbalanced load acts. The magnitude of damage that can be caused to the surroundings of the utility pole 200 when the utility pole 200 tilts or collapses is called an impact level. The impact level calculation device according to the present embodiment is a device that calculates the impact level that occurs when a utility pole with a branch line tilts or collapses.

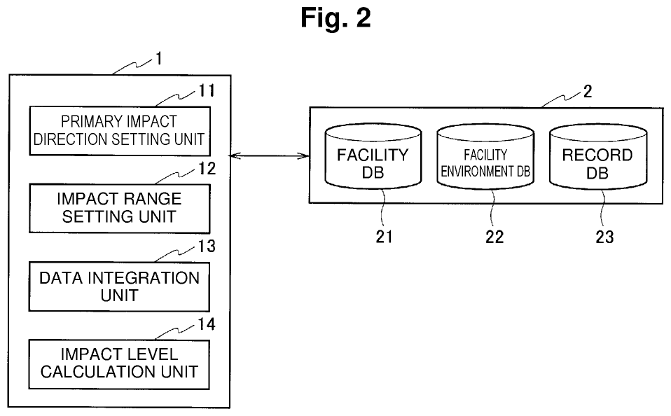

The configuration of the impact level calculation device 1 according to the first embodiment will be described with reference to FIG. 2. The impact level calculation device 1 shown in FIG. 2 includes a primary impact direction setting unit 11, an impact range setting unit 12, a data integration unit 13, and an impact level calculation unit 14. The impact level calculation device 1 is connected to a DB group 2 formed of a facility database (DB) 21, a facility environment DB 22, and a record DB 23. The impact level calculation device 1 can read information from the DB group 2 and write information to the DB group 2 as required.

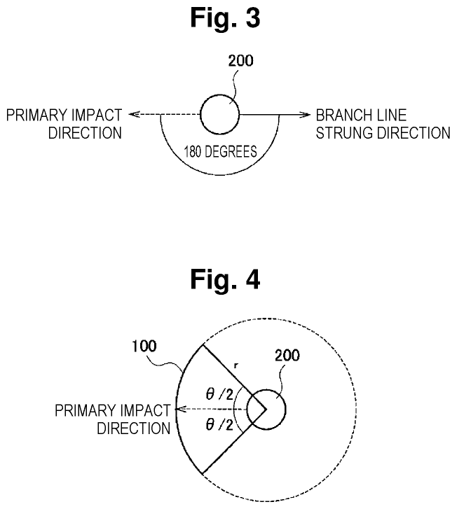

The primary impact direction setting unit 11 sets a primary impact direction representing the direction of the unbalanced load applied to the utility pole 200. The external forces applied to the utility pole 200 can be modeled so as to be biased in the direction opposite by 180 degrees from the direction in which the branch line is strung (hereinafter referred to as a branch line strung direction). The primary impact direction setting unit 11 sets the direction opposite by 180 degrees from the branch line strung direction in the horizontal plane as the primary impact direction. FIG. 3 shows the relationship between the branch line strung direction and the primary impact direction around a utility pole 200 with a branch line. The primary impact direction setting unit 11 reads values recorded in the facility DB 21 to identify the branch line strung direction. When a plurality of branch lines 210 are attached to the single utility pole 200, the primary impact direction setting unit 11 determines the direction of the combined force that is the combination of forces acting on the plurality of branch lines 210 in the horizontal plane and sets the direction opposite by 180 degrees from the determined combined force direction as the primary impact direction. When no information for identifying the branch line strung direction is recorded in the facility DB 21, the primary impact direction setting unit 11 may accept an input of or arbitrarily set the branch line strung direction or the primary impact direction each time or may advance the process procedure without setting the primary impact direction.

Based on the primary impact direction and the height of the utility pole 200, the impact range setting unit 12 sets as an impact range a range over which damage can occur, that is, the range over which the impact level should be calculated. When the utility pole 200 collapses, the range over which damage can occur is believed based on probability to exist within a certain range with respect to the primary impact direction for a variety of reasons, such as differences in the tension acting on the cables 220, the state of the covering on the ground surface where the utility pole 200 is built, and weather conditions. The impact range setting unit 12 therefore sets a circle drawn around the utility pole 200 and having a radius r equal to the height of the utility pole 200 (pole length) and sets as an impact range 100 of the utility pole 200 a fan-shaped range including the primary impact direction and having an impact angle θ as the central angle, as shown in FIG. 4. The pole length of the utility pole 200 recorded in the facility DB 21 is read and used as the radius r. The radius r may be recorded in the facility DB 21. As the impact angle θ, an angle set in advance may be used, or an input of the impact angle θ may be accepted each time. When the radius r is unknown for one reason or another, an arbitrary radius r may be set each time, or the pole length of utility poles most frequently used in the region may be used as the radius r.

In FIG. 4, the impact range 100 is evenly divided into θ/2 portions on opposite sides of the primary impact direction. It is, however, noted that the impact range 100 may not be evenly divided into portions on opposite sides of the primary impact direction.

When no primary impact direction is set, the impact range setting unit 12 sets the circle drawn around the utility pole 200 and having the radius r as the impact range. The impact level calculation unit 14, which will be described later, may multiply the impact level calculated based on the impact range set at 360 degrees by the ratio of the impact angle θ to 360 degrees corresponding to the entire circle as the impact level of the utility pole 200. For example, when the impact angle is 90 degrees, the impact level calculation unit 14 multiplies the impact level determined based on the impact range set at 360 degrees by a quarter.

The impact level calculation unit 14 reads the environmental information in the position of the utility pole 200 from the facility environment DB 22, extracts targets that fall within the impact range and can be damaged, and calculates and sums the impact levels. Conceivable examples of the targets that can be damaged include pedestrians and buildings in the impact range.

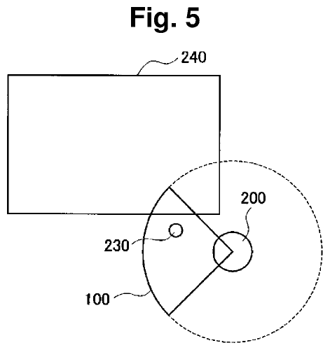

An example of the calculation of the impact level will be described with reference to FIG. 5. A pedestrian 230 and a building 240 are present in the impact range 100 of the utility pole 200. The impact level calculation unit 14 calculates the impact level on each of the pedestrian 230 and the building 240 and sums the impact levels to determine the impact level of the utility pole 200.

In FIG. 5, the pedestrian 230 is expressed as a single pedestrian, and the impact calculation unit 14 can instead calculate the impact level using the population density in the position of the utility pole 200. For example, the impact level calculation unit 14 reads the population density (persons/km² ) in the position of the utility pole 200 from the facility environment DB 22 and multiplies the area (km² ) of the impact range 100 of the utility pole 200 by the population density and the damage intensity per person (amount of money/person) to determine the impact level on the pedestrian 230. The damage intensity per person is set in advance. In the above description, the unit of the impact level on the pedestrian 230 is the amount of money, but not necessarily.

The building 240 present in the impact range 100 can be extracted by using building data recorded in the facility environment DB 22. The impact level calculation unit 14 determines the damage intensity (amount of money/building) for each building present in the impact range 100 and sums the determined damage intensities to determine the impact level on the buildings. A common damage intensity may be used for each of the buildings.

The impact level calculation unit 14 sums the impact levels on pedestrians and buildings to determine the impact level of the utility pole 200.

The calculation of the impact level is not limited to the calculation described above. For example, when a road falls within the impact range 100, the impact level calculation unit 14 may determine the impact level on vehicles traveling on the road. The impact level calculation unit 14 can determine the impact level on vehicles based on the traffic volume on the road, as in the case of pedestrians.

The impact level calculation device 1 uses information stored in the facility DB 21 and the facility environment DB 22 to determine the primary impact direction, the impact range, and the impact level.

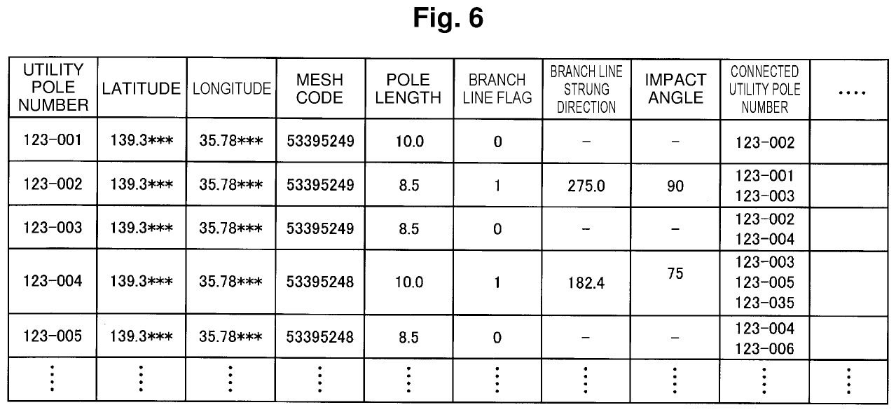

The facility DB 21 stores facility information on facilities, such as utility poles. FIG. 6 shows an example of the facility information stored in the facility DB 21. In the example shown in FIG. 6, the facility DB 21 stores, on a utility pole basis, a utility pole number for identifying the utility pole, the latitude and longitude representing the position of the utility pole, a mesh code representing the area where the utility pole is present, the pole length representing the length of the utility pole, a branch line flag representing whether or not a branch line is attached to the utility pole, the branch line strung direction, the impact angle, and a connected utility pole number representing a utility pole that holds the same cable held by the utility pole in question. The branch line flag is used to determine whether or not the utility pole in question is a target to be processed by the impact level calculation device 1. The branch line strung direction is expressed, for example, in degrees in a horizontal plane with north being θ degrees and the clockwise direction being a positive angular direction. The branch line strung direction is used to set the primary impact direction. The pole length and the impact angle are used to set the impact range. The mesh code is used to acquire the environmental information in the position of the utility pole from the facility environment DB 22, which will be described later.

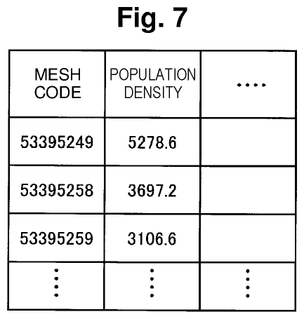

The facility environment DB 22 stores environmental information used by the impact level calculation unit 14 to calculate the impact level. The environmental information is information on the environment where facilities are installed (population density data, for example) and is formed of a variety of pieces of published, sold, or independently maintained information organized on a mesh code basis. FIG. 7 shows an example of the environmental information stored in the facility environment DB 22. In the example shown in FIG. 7, the facility environment DB 22 stores the population density on a mesh code basis. The environmental information is published or sold as regional mesh values in many cases. Therefore, the facility environment DB 22 stores the environmental information on a mesh code basis, and the facility DB 21 stores mesh codes each representing the area where a utility pole is present. The regional mesh is a mesh formed of regions based on the latitude and longitude. A mesh code is assigned to each meshed portion based on a rule. For example, in Japan, a standard regional mesh includes a primary mesh having a side length of about 80 km, a secondary mesh having a side length of about 10 km, and a tertiary mesh having a side length of about 1 km. Some environmental information, such as building data, is not maintained or is difficult to be maintained in the form of mesh data. Such data is stored in the installation environment DB 22 in a suitable form other than mesh data, for example, in the form of polygon data.

The impact level calculation device 1 stores in the record DB 23 a variety of pieces of information generated in the process of calculating the impact level.

The record DB 23 temporarily or permanently saves a variety of pieces of information generated in the process of calculating the impact level. For example, the impact level calculation device 1 saves the primary impact direction determined from the branch line strung direction for use in setting the impact range. The impact level calculation device 1 may record all data calculated in the process of calculating the impact level in the record DB 23 or may save the data in a memory. It is assumed that all data calculated in the process of calculating the impact level are temporarily or permanently stored irrespective of how to store the data.

The record DB 23 may store the impact level calculated by the impact level calculation device 1 for each pole with a branch line.

The data integration unit 13 integrates the information stored in the facility DB 21, information stored in the facility environment DB 22, and information stored in the record DB 23 with one another as in the same manner employed in a geographic information system (GIS) by using the position information as the axis. For example, regarding a certain single utility pole stored in the facility DB 21, a variety of pieces of environmental information on the position where the utility pole is installed and a variety of pieces of information generated in the process of calculating the impact level of the utility pole are integrated with each other, whereby the variety of pieces of information can be read or written as required.

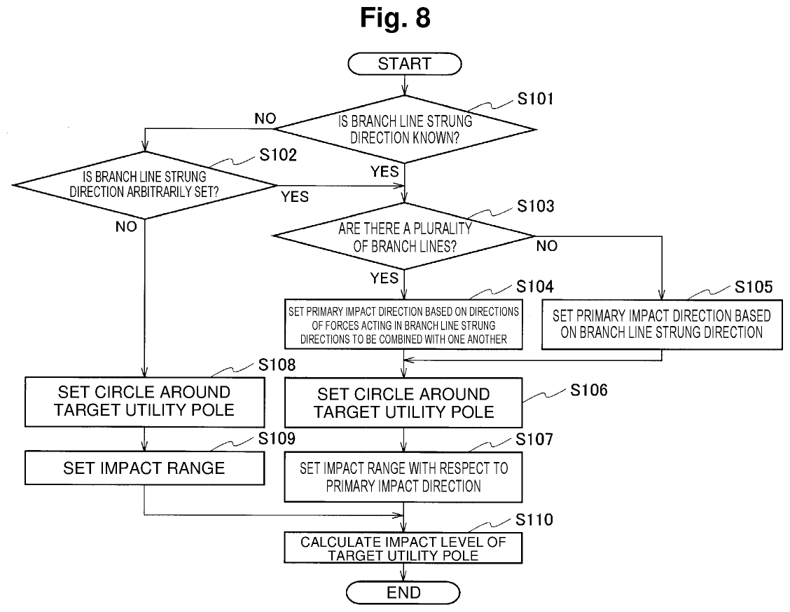

The procedure of processes carried out by the impact level calculation device 1 will be described with reference to FIG. 8. The processes shown in FIG. 8 are carried out for each utility pole with a branch line having the branch line flag turned on. A pole with a branch line to be processed is hereinafter referred to as a target utility pole.

In step S101, the primary impact direction setting unit 11 attempts to acquire the branch line strung direction of the target pole from the facility DB 21 and determines whether or not the branch line strung direction is known.

When the branch line strung direction is unknown, the primary impact direction setting unit 11 accepts an input of the branch line strung direction or arbitrarily sets the branch line strung direction in step S102. When no branch line strung direction is set, the impact level calculation device 1 proceeds to the process in step S108.

In step S103, the primary impact direction setting unit 11 determines whether or not there are a plurality of branch line strung directions.

When there are a plurality of branch line strung directions, the primary impact direction setting unit 11 sets the primary impact direction based on the direction of the forces acting in the branch line strung directions to be combined with one another in step S104.

When there is only one branch line strung direction, the primary impact direction setting unit 11 sets the direction opposite by 180 degrees from the branch line strung direction as the primary impact direction in step S105.

In step S106, the impact range setting unit 12 acquires the pole length of the target utility pole from the facility DB 21 and sets a circle drawn around the target utility pole and having a radius equal to the pole length.

In step S107, the impact range setting unit 12 sets the impact range having the impact angle θ in the circle set in step S106 with respect to the primary impact direction.

On the other hand, when no branch line strung direction is set, that is, when no primary impact direction is set, the impact range setting unit 12 acquires the pole length of the target utility pole from the facility DB 21 and sets a circle drawn around the target utility pole and having a radius equal to the pole length in step S108. In step S109, the impact range setting unit 12 sets the entire interior of the circle as the impact range.

In step S110, the impact level calculation unit 14 acquires the environmental information from the facility environment DB 22 based on the impact range and calculates the impact level of the target utility pole. When no primary impact direction is set, the impact level calculation unit 14 may use the impact level calculated based on the impact range and multiplied by the ratio of the impact angle θ to 360 degrees corresponding to the entire circle as the impact level of the target utility pole.

As described above, in the impact level calculation device according to the present embodiment, the primary impact direction setting unit 11 sets the primary impact direction, which represents the direction of the unbalanced load acting on a utility pole, based on the direction in which the branch line attached to the utility pole is strung. The impact range setting unit 12 sets the impact range over which damage can occur based on the primary impact direction and the pole length of the utility pole. The impact level calculation unit 14 extracts a target that falls within the impact range and may be damaged and calculates the impact level. Since the impact level in consideration of the impact factors specific to the utility pole with a branch line can thus be calculated, the impact level on the surroundings of the utility pole with a branch line, which is considered to have a particular risk, can be evaluated.

According to the present embodiment, since the impact range setting unit 12 sets an impact range with respect to the primary impact direction and based on the impact angle, the impact level in consideration of uncertainty caused when the branch line function is lost can be evaluated.

### Second Embodiment

The impact level calculation device according to a second embodiment will be described below with reference to the drawings.

Since utility poles are connected to each other via cables, significant tilt or collapse of one of the utility poles transmits the unbalanced load to the utility pole connected via the cables (hereinafter referred to as a connected utility pole). As a result, it is conceivable that the connected utility pole also tilts or collapses, causing damage to the surroundings of the connected utility poles. The impact level calculation device according to the second embodiment calculates a chain reaction impact level in consideration of a chain reaction on a connected utility pole in the case where a utility pole with a branch line tilts or collapses.

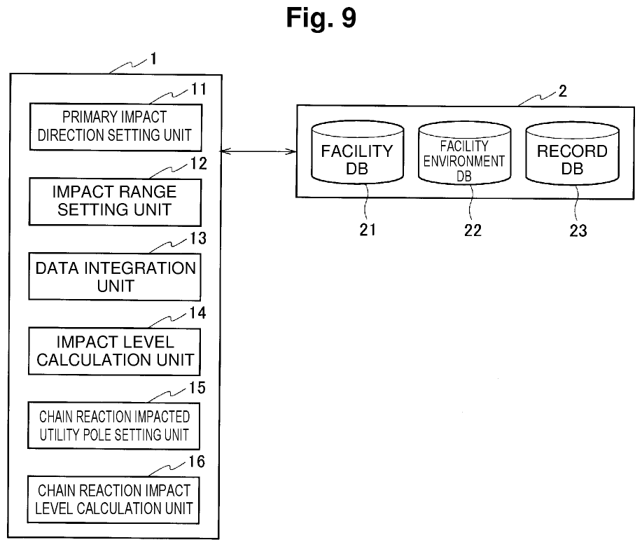

The configuration of the impact level calculation device 1 according to the second embodiment will be described with reference to FIG. 9. The impact level calculation device 1 shown in FIG. 9 includes the primary impact direction setting unit 11, the impact range setting unit 12, the data integration unit 13, the impact level calculation unit 14, a chain reaction impacted utility pole setting unit 15, and a chain reaction impact level calculation unit 16. The impact level calculation device 1 according to the second embodiment is the impact level calculation device 1 according to the first embodiment to which the chain reaction impacted utility pole setting unit 15 and the chain reaction impact level calculation unit 16 are added. The same portions as those in the first embodiment will not be described.

When a target utility pole tilts or collapses, the chain reaction impacted utility pole setting unit 15 sets a utility pole that is likely to tilt or collapse in a chain reaction as a chain reaction impacted utility pole. For example, when the number of adjacent utility poles to be impacted is one, the chain reaction impacted utility pole setting unit 15 sets the utility pole directly adjacent to the target utility pole among the utility poles connected to the target utility pole via cables as the chain reaction impacted utility pole. Specifically, when the utility pole that holds the middle of a certain single cable is the target utility pole, two poles that hold the cable on the upstream and downstream of the target utility pole are each the chain reaction impacted utility pole. The number of impacted adjacent utility poles may be arbitrarily set.

The chain reaction impacted utility pole setting unit 15 reads connection information of the target utility pole from the facility DB 21 and sets a chain reaction impacted utility pole. When no connection information can be acquired, the chain reaction impacted utility pole setting unit 15 may set each of the utility poles adjacent to the target utility pole as the chain reaction impacted utility pole irrespective of the cable connection state.

The chain reaction impact level calculation unit 16 calculates the impact level for each of the chain reaction impacted utility poles and sums the impact levels of the target utility pole and the chain reaction impacted utility poles to determine a chain reaction impact level.

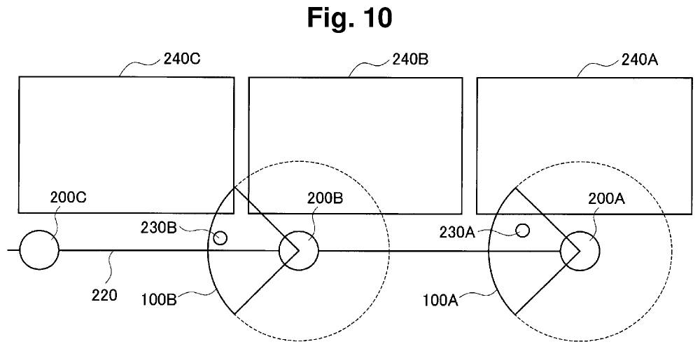

An example of the calculation of the chain reaction impact level will be described with reference to FIG. 10. Utility poles 200A, 200B, and 200C in FIG. 10 are connected to each other via a cable 220. The utility pole 200A is assumed to be the target utility pole. When the number of impacted adjacent utility poles is set at one, the pole 200B is a chain reaction impacted utility pole, and the utility pole 200C is not a chain reaction impacted utility pole.

The impact level calculation device 1 sets an impact range 100A of the target utility pole 200A in the same manner in the first embodiment and calculates the impact level of the utility pole 200A based on the impact range 100A. Since a pedestrian 230A and a building 240A are present in the impact range 100A, the impact level calculation device 1 determines and sums the impact levels on the pedestrian 230A and the building 240A.

The impact level calculation device 1 also sets an impact range 100B of the chain reaction impacted utility pole 200B and calculates the impact level of the chain reaction impacted utility pole 200B based on the impact range 100B. In this process, the impact range 100B may be the same as the impact range 100A of the utility pole 200A, or the impact range 100B may be set based on information representing the chain reaction impacted utility pole 200B and stored in the facility DB 21.

Since a pedestrian 230B and buildings 240B and 240C are present in the impact range 100B, the impact level calculation device 1 determines and sums the impact levels on the pedestrian 230B and the buildings 240B and 240C.

The chain reaction impact level calculation unit 16 sums the impact levels of the utility pole 200A and chain reaction impacted utility pole 200B to determine the chain reaction impact level of the pole 200A.

In FIG. 10, assuming that the utility pole 200B is the target utility pole, the utility poles 200A and 200C are each the chain reaction impacted pole. The chain reaction impact level calculation unit 16 calculates the impact levels of the utility poles 200A, 200B, and 200C and sums the impact levels to determine the chain reaction impact level of the utility pole 200B.

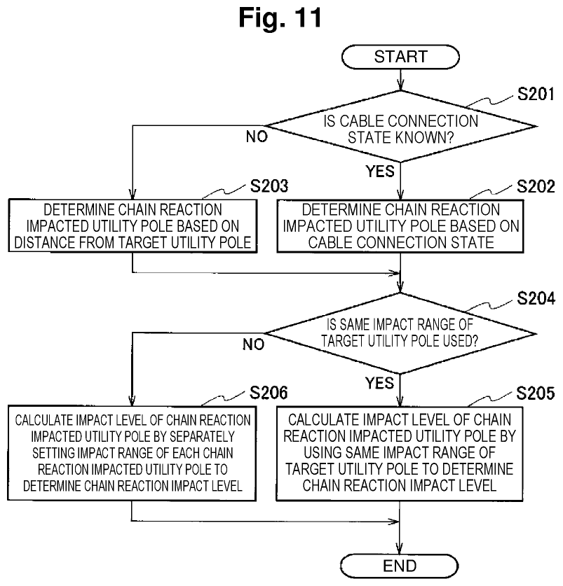

The procedure of processes carried out by the impact level calculation device 1 will be described with reference to FIG. 11. The processes shown in FIG. 11 are carried out after the processes shown in FIG. 8 are carried out on a target utility pole and when the chain reaction impact level of the target utility pole is calculated. Whether or not to calculate the chain reaction impact level of the target utility pole is recorded in the facility DB 21. Alternatively, when the distance between the target utility pole and a utility poles adjacent thereto is longer than a predetermined reference, the target utility pole may be included in the calculation of the chain reaction impact level. The longer the distance between the utility poles is, the greater the tension acting on the cable is, and hence the greater the load acting on the poles is.

In step S201, the chain reaction impacted utility pole setting unit 15 attempts to acquire the connection state of the target utility pole from the facility DB 21 and determines whether or not the connection state is known.

When the connection state is known, the chain reaction impacted utility pole setting unit 15 determines a chain reaction impacted utility pole based on the cable connection state in step S202.

When the connection state is unknown, the chain reaction impacted utility pole setting unit 15 determines a chain reaction impacted utility pole based on the distance from the target utility pole in step S203. For example, the chain reaction impacted utility pole setting unit 15 sets a utility pole present in a predetermined range drawn around the target utility pole as the chain reaction impacted utility pole.

In step S204, the chain reaction impact level calculation unit 16 evaluates whether or not the impact range of the chain reaction impacted utility pole is the same as the impact range of the target utility pole. Whether or not to use the same impact range as that of the target utility pole is set in advance.

When the same impact range as that of the target utility pole is used, the chain reaction impact level calculation unit 16 applies the same impact range as that of the target utility pole to the position of each chain reaction impacted utility pole to calculate the impact level of the chain reaction impacted utility pole in step S205. The chain reaction impact level calculation unit 16 sums the impact levels of the target utility pole and the chain reaction impacted utility poles to determine the chain reaction impact level.

When the same impact range as that of the target utility pole is not used, the impact range is set separately for each of the chain reaction impacted utility poles, and the impact levels of the chain reaction impacted utility poles are calculated in step S206. The impact level of each of the chain reaction impacted utility poles can be determined by carrying out the processes shown in FIG. 8 for the chain reaction impacted utility pole. The chain reaction impact level calculation unit 16 sums the impact levels of the target utility pole and the chain reaction impacted utility poles to determine the chain reaction impact level.

As described above, according to the present embodiment, providing the chain reaction impacted utility pole setting unit 15, which sets a chain reaction impacted utility pole that causes damage in a chain reaction when the target utility pole tilts or collapses, and the chain reaction impact level calculation unit 16, which calculates and sums the impact level of each chain reaction impacted utility pole, allows evaluation of the impact level on a wider area when the target utility pole tilts or collapses.

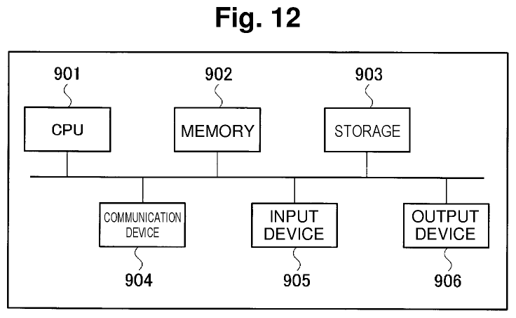

The first and second impact level calculation devices 1 can, for example, each be a general-purpose computer system including a central processing unit (CPU) 901, a memory 902, a storage 903, a communication device 904, an input device 905, and an output device 906, as shown in FIG. 12. In the computer system, the CPU 901 executes a predetermined program loaded on the memory 902 to achieve the impact level calculation device 1. The program can be recorded on a computer-readable recording medium, such as a magnetic disk, an optical disk, and a semiconductor memory, or can be distributed via a network.

Reference Signs List

| | |
|---|---|
| 1 | Impact level calculation device |
| 11 | Primary impact direction setting unit |
| 12 | Impact range setting unit |
| 13 | Data integration unit |
| 14 | Impact level calculation unit |
| 2 | DB group |
| 21 | Facility DB |
| 22 | Facility environment DB |
| 23 | Record DB |

1. An impact level calculation device for calculating an impact level representing a level of damage caused to surroundings of a utility pole with a branch line when the utility pole tilts or collapses, the device comprising:
a primary impact direction setting unit that sets a primary impact direction based on a direction in which the branch line of the utility pole is strung;
an impact range setting unit that sets, based on the primary impact direction, an impact range representing a range of the damage caused when the utility pole tilts or collapses; and
an impact level calculation unit that extracts targets that fall within the impact range and calculates and sums the impact levels on each of the targets.

2. The impact level calculation device according to claim 1,
wherein the impact range setting unit sets as the impact range a fan-shaped range that includes the primary impact direction, has a radius equal to a height of the utility pole, and has a predetermined central angle.

3. The impact level calculation device according to claim 1
wherein the primary impact direction setting unit sets the primary impact direction based on a direction of a combined force that is a combination of forces acting on a plurality of branch lines.

4. The impact level calculation device according to claim 1, further comprising:
a chain reaction impacted utility pole setting unit that sets chain reaction impacted utility poles that cause damage in a chain reaction when the utility pole tilts or collapses; and
a chain reaction impact level calculation unit that calculates and sums the impact levels of the chain reaction impacted utility poles.

5. An impact level calculation method for calculating an impact level representing a level of damage caused to surroundings of a utility pole with a branch line when the utility pole tilts or collapses, the method comprising the steps of:
setting a primary impact direction based on a direction in which the branch line of the utility pole is strung;
setting, based on the primary impact direction, an impact range representing a range of the damage caused when the utility pole tilts or collapses; and
extracting targets that fall within the impact range and calculating and summing the impact levels on each of the targets.

6. The impact level calculation method according to claim 5,
wherein the step of setting the impact range sets as the impact range a fan-shaped range that includes the primary impact direction, has a radius equal to a height of the utility pole, and has a predetermined central angle.

7. The impact level calculation method according to claim 5
wherein the step of setting the primary impact direction sets the primary impact direction based on a direction of a combined force that is a combination of forces acting on a plurality of branch lines.

8. The impact level calculation method according to claim 5, the method further comprising the steps of:
setting chain reaction impacted utility poles that tilt or collapse in a chain reaction when the utility pole tilts or collapses; and
calculating and summing the impact levels of each of the chain reaction impacted utility poles.

9. The impact level calculation device according to claim 2,
wherein the primary impact direction setting unit sets the primary impact direction based on a direction of a combined force that is a combination of forces acting on a plurality of branch lines.

10. The impact level calculation device according to claim 2, further comprising:
a chain reaction impacted utility pole setting unit that sets chain reaction impacted utility poles that cause damage in a chain reaction when the utility pole tilts or collapses; and
a chain reaction impact level calculation unit that calculates and sums the impact levels of the chain reaction impacted utility poles.

11. The impact level calculation device according to claim 3, further comprising:
a chain reaction impacted utility pole setting unit that sets chain reaction impacted utility poles that cause damage in a chain reaction when the utility pole tilts or collapses; and
a chain reaction impact level calculation unit that calculates and sums the impact levels of the chain reaction impacted utility poles.

12. The impact level calculation method according to claim 6,
wherein the step of setting the primary impact direction sets the primary impact direction based on a direction of a combined force that is a combination of forces acting on a plurality of branch lines.

13. The impact level calculation method according to claim 6, the method further comprising the steps of:
setting chain reaction impacted utility poles that tilt or collapse in a chain reaction when the utility pole tilts or collapses; and
calculating and summing the impact levels of each of the chain reaction impacted utility poles.

14. The impact level calculation method according to claim 7, the method further comprising the steps of:
setting chain reaction impacted utility poles that tilt or collapse in a chain reaction when the utility pole tilts or collapses; and
calculating and summing the impact levels of each of the chain reaction impacted utility poles.
